(19) United States
(12) Patent Application Publication
(10) Pub. No.: US 2008/0216453 A1
(43) Pub. Date: Sep. 11, 2008

(54) Heated Sealing Strip

(75) Inventor: Norbert Giesen, Geldern (DE)

Correspondence Address: THE OLLILA LAW GROUP LLC, 2060 BROADWAY, SUITE 300, BOULDER, CO, 80302, US

(73) Assignee: Norgren, Inc., Littleton, CO (US)

(21) Appl. No.: 11/917,040

(22) PCT Filed: Jun. 13, 2005
(86) PCT No.: PCT/EP05/06298

§ 371 Date: Dec. 10, 2007

(51) Int. Cl. B65B 51/10; B23P 17/04

(52) U.S. Cl. 53/478; 53/370.8; 29/592

(57) ABSTRACT

An actuator and method for a heated sealing strip is disclosed. The actuator and method comprise embedding at least one wire (218) into a sealing strip (216). A power supply (30) is connected to the wire (218). An electrical current is run from the power supply (430) through the wire (218), heating the sealing strip (216).

### BACKGROUND OF THE INVENTION

1. Field of the Invention

The invention is related to the field of actuators, and in particular, to an actuator with a heated sealing strip.

2. Description of the Prior Art

Actuators come in many styles and shapes. One type of activator is a rodless cylinder, for example a Lintra® Rodless cylinder M/46000 from Norgren. Rodless cylinders differ from basic cylinders in that no piston rod extends outside the cylinder body. Instead, an internal piston is connected to an external carriage, by means of a magnetic or mechanical coupling system. Rodless cylinders are ideal for long stroke applications because they are unaffected by rod overhang, bending, piston binding, and uneven seal wear, and for use in confined areas where space is a premium. Unfortunately, the rodless design may necessitate a long sealing strip running the length of the rodless cylinder. The sealing strip is typically used to seal the pneumatic chamber of the rodless cylinder. Some sealing strips may stiffen when exposed to low temperatures, causing a loss of pressure and efficiency in the actuator. It would be desirable to have an actuator that did not lose efficiency at low temperature.

Therefore there is a need for a sealing strip that functions over a wider temperature range.

### SUMMARY OF THE INVENTION

A system and method for a heated sealing strip is disclosed. The system and method comprise embedding at least one wire into a sealing strip. A power supply is connected to the wire. An electrical current is run from the power supply through the wire, heating the sealing strip.

### BRIEF DESCRIPTION OF THE DRAWINGS

FIG. 1 is an isometric view of a rodless cylinder in an example embodiment of the invention.

FIG. 2 is a sectional view of detail area AA from FIG. 1, in an example embodiment of the invention.

FIG. 3 is a sectional side view of rodless cylinder 300 in one example embodiment of the invention.

FIG. 4a is a diagram of two wires embedded inside a sealing strip connected to a power supply in one example embodiment of the invention.

FIG. 4b is a diagram of two wires embedded inside a sealing strip connected to a power supply in another example embodiment of the invention.

FIG. 4c is a diagram of a wire embedded inside a sealing strip connected to a power supply in another example embodiment of the invention.

FIG. 5 is a flow chart for heating a sealing strip in one example embodiment of the invention.

### DETAILED DESCRIPTION OF THE PREFERRED EMBODIMENT

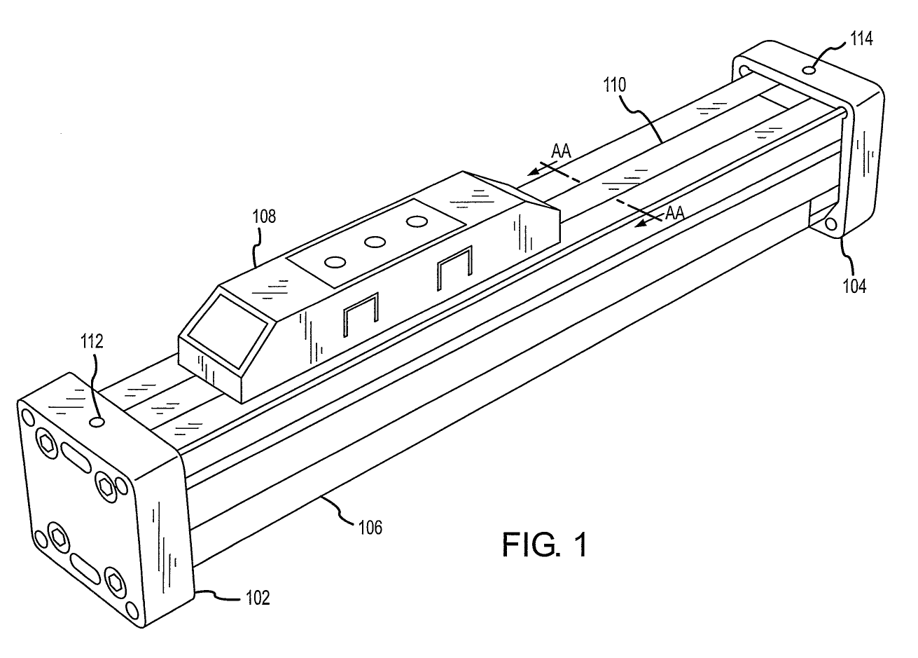

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is an isometric view of a rodless cylinder in an example embodiment of the invention. Rodless cylinder has endcaps 102 and 104, main body 106, carriage 108, cover strip 110, and air ports 112 and 114. In operation, air is forced into air ports 112 or 114, driving carriage from one endcap to the other endcap.

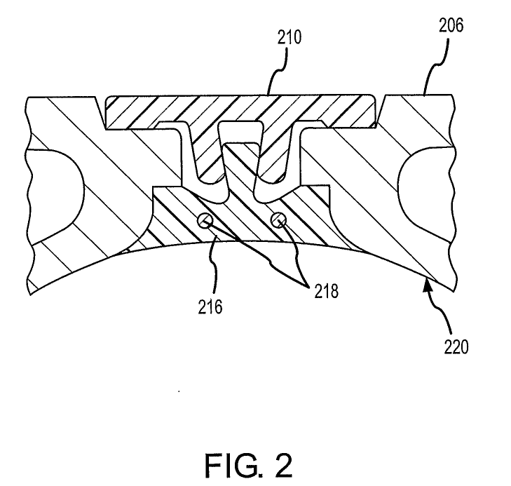

FIG. 2 is a sectional view of detail area AA from FIG. 1, in one example embodiment of the invention. FIG. 2 shows main body 206 that forms the inner wall 220 of a pneumatic chamber. Sealing strip 216 fits into and seals the top channel formed into main body 206. Sealing strip 216 has wires 218 embedded into sealing strip 216. The wires 218 in sealing strip 216 are typically used to stiffen sealing strip 216 and may be made from steel or some other metal. In one example embodiment of the invention, the wires 218 in sealing strip 216 are also used as heating elements. By running an electrical current through the wires 218, the sealing strip may be heated. The heated sealing strip retains it's flexibility at lower temperatures compared to a non-heated sealing strip. Cover strip 210 attaches to a feature in the top of sealing strip 216.

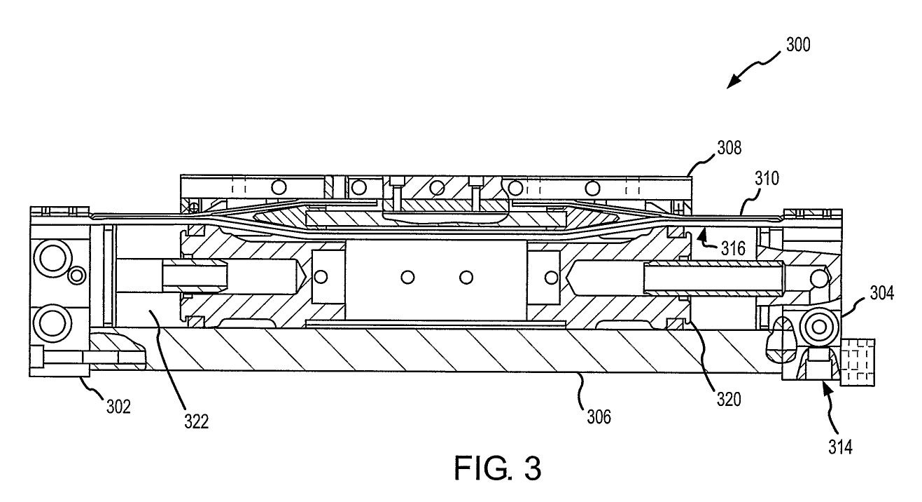

FIG. 3 is a sectional side view of rodless cylinder 300 in one example embodiment of the invention. Rodless cylinder 300 comprises endcaps 302 and 304, main body 306, carriage 308, cover strip 310, pneumatic chamber 322, and sealing strip 316. Air port 314 is formed into endcap 304. An air port (not shown) is also formed into endcap 302. Carriage 308 is attached to internal piston 320. Sealing strip 316 and cover strip 310 may be one continuous piece or may be two pieces, one piece at each end of the rodless cylinder, with the carriage in the middle.

In operation, carriage 308 is moved from one endcap to the other endcap as air is forced into the air port in endcap 302 or air port 314, driving internal piston inside pneumatic chamber 322. As the carriage moves towards one endcap, the leading end of the carriage forces sealing strip 316 down and away from the top channel and forces the cove strip 310 up and away from the top channel. As the carriage passes by, the trailing end of the carriage forces the sealing strip 316 back up into top channel and forces cover strip 310 back down and onto the retaining feature on sealing strip 316. As the operating temperature gets colder, sealing strip tends to get stiffer. As the sealing strip gets stiffer, the carriage may have difficulty re-seating sealing strip into the top channel as the carriage passes by. When the sealing strip is not properly seated into the top channel, air leaks may occur, reducing the efficiency of the rodless cylinder.

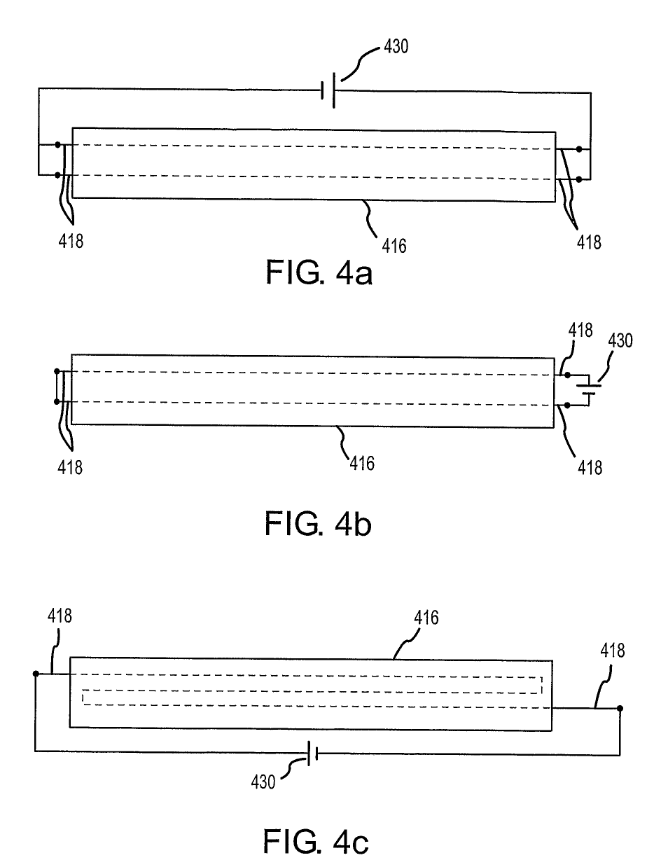

Some sealing strips already contain wires embedded into the sealing strip to add stiffness to the sealing strip. Typically the wires are called internal reinforcement wires and may be made from steel or some other metal. By connecting the wires to a power supply, an electrical current can be run through the wires, thereby heating the wires and the sealing strip. FIG. 4 is a drawing of the wires embedded inside a sealing strip and connected to a power supply in one example embodiment of the invention. FIG. 4 comprises a sealing strip 416, wires 418, and a power supply 430. FIG. 4a shows the power supply 430 connected to the wires 418 at both ends of the sealing strip 416. FIG. 4b shows the wires 418 connected together at one end of the sealing strip 416 forming a loop. The power supply 430 is connected to the wires 418 at the other end of the sealing strip 416. FIG. 4c shows a single wire embedded into sealing strip 416 forming a serpentine path between the two ends of the sealing strip. Power supply 430 is connected to each end of wire 418. Many other wire configurations are possible.

In one example embodiment of the invention, the power supply may be 24 volts. The current through the wires may be controlled to provide a given amount of heating, for example 12 Watts. A temperature sensor may be used to switch the power supply on when the temperature falls below a threshold. In another example embodiment of the invention, the sealing strip may be heated for a predetermined length of time at system power-up. Heating wires may be added to sealing strips that do not require internal stiffeners.

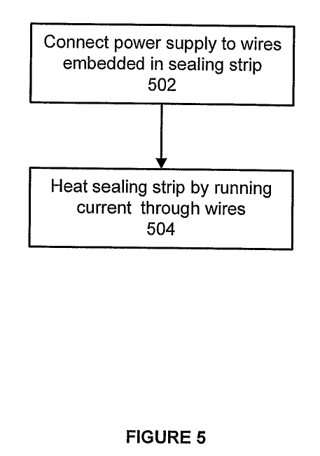

FIG. 5 is a flow chart for heating a sealing strip in one example embodiment of the invention. At step 502 a power supply is connected to a wire embedded inside a sealing strip. At step 504 an electrical current is run from the power supply through the wire embedded in the sealing strip, thereby heating the sealing strip.

We claim:

1. A method, characterized by:
connecting at least one wire, running inside a sealing strip, to a power source (502);
heating the sealing strip by running an electrical current from the power source through the at least one wire (504).

2. The method of claim 1 characterized by the sealing strip being heated only when the temperature falls below a threshold.

3. The method of claim 1 characterized by the sealing strip being in a rodless cylinder.

4. The method of claim 1 characterized by the sealing strip being a polyurethane material and the at least one wire being a steel wire.

5. The method of claim 1 characterized by the at least one wire also being used as an internal reinforcement wire for the sealing strip.

6. The method of claim 1 characterized by the sealing strip being heated for a predetermined time when the power source is started.

7. A method, characterized by:
forming an electrically conductive wire loop in a sealing strip;
beating the sealing strip by running a current through the electrically conductive wire loop (504).

8. The method of claim 7 characterized by the sealing strip being heated only when the temperature falls below a threshold.

9. The method of claim 7 characterized by the electrically conductive wire loop being formed by coupling together a first end of two wires running inside the sealing strip.

10. The method of claim 7 characterized by the sealing strip being in a rodless cylinder.

11. The method of claim 7 characterized by the wire loop also being used as internal reinforcement to the sealing strip.

12. The method of claim 7 characterized by the sealing strip being heated for a predetermined time when the power source is initialized.

13. An actuator, characterized by:
a sealing strip (416) configured to retain pneumatic pressure inside the actuator;
at least one wire (418) embedded inside the sealing strip;
a power supply (430) connected to the at least one wire, where the power supply is configured to run an electrical current through the at least one wire.

14. The activator of claim 13 characterized by the at least one wire (418) being configured to stiffen the sealing strip.

15. The activator of claim 13 characterized by the power supply being approximately 24 volts.

16. The activator of claim 13 characterized by the current being controlled to supply approximately 12 watts.

17. The activator of claim 13 characterized by having the at least one wire fabricated from steel and the sealing strip fabricated from a polyurethane material.

18. The activator of claim 13, further characterized by:
a temperature sensor;
a processor configured to read the temperature sensor and control the power supply such that the power supply only provides the current to the at least one wire when the temperature is below a threshold.

19. The activator of claim 13 characterized by the activator being of the rodless cylinder type.

20. A method of fabricating a sealing strip characterized by:
embedding an electrically conductive material into a sealing strip;
connecting the electrically conductive material to a power supply.

21. An activator, characterized by:
a means for sealing a pneumatic chamber in a rodless cylinder;
a means for heating the sealing means.
